(19) United States
(12) Patent Application Publication
(10) Pub. No.: US 2023/0382411 A1
(43) Pub. Date: Nov. 30, 2023

(54) VEHICLE CONTROL DEVICE, VEHICLE, VEHICLE CONTROL METHOD, AND NON-TRANSITORY STORAGE MEDIUM

(71) Applicant: TOYOTA JIDOSHA KABUSHIKI KAISHA, Toyota-shi (JP)

(72) Inventor: Hirofumi MORI, Hadano-shi (JP)

(21) Appl. No.: 18/299,109

(22) Filed: Apr. 12, 2023

(30) Foreign Application Priority Data
May 27, 2022 (JP) 2022-087095

(51) Int. Cl. B60W 50/10

(52) U.S. Cl. CPC B60W 50/10; B60W 2540/10; B60W 2554/802; B60W 2554/4041

(57) ABSTRACT

A vehicle control device comprises a memory and a processor coupled to the memory. The processor is configured to restrict reaction force added to an accelerator pedal of a driver's vehicle by a reaction force add section configured to add reaction force to the accelerator pedal of the driver's vehicle in a case in which traveling of the driver's vehicle under a specific condition continues for a fixed period of time or greater.

### CROSS-REFERENCE TO RELATED APPLICATION

This application is based on and claims priority under 35 USC 119 from Japanese Patent Application No. 2022-087095 filed on May 27, 2022, the disclosure of which is incorporated by reference herein.

### BACKGROUND

### Technical Field

The present disclosure relates to a vehicle control device, a vehicle, a vehicle control method, and a non-transitory storage medium stored with a vehicle control program.

### Related Art

For example, in technology disclosed in Japanese Patent Application Laid-Open (JP-A) No. 2003-205760, a vehicle state and a vehicle surroundings travel environment is detected, a risk level is computed for the driver's vehicle or for surroundings of the driver's vehicle, and an increase value for reaction force to an accelerator pedal is monotonously increased as the computed risk level increases. In the technology described in JP-A No. 2003-205760 the risk level is computed based on a slack time indicating a time until the driver's vehicle will run into the back of the vehicle ahead, and based on an inter-vehicle time indicating a time until the driver's vehicle will reach the current position of the vehicle ahead.

However, in the technology described in JP-A No. 2003-205760, there is still a possibility that reaction force will be added to the accelerator pedal even in a situation, for example, in which a driver of the driver's vehicle might be thought to be performing stable driving such that the driver's vehicle performs travel following the vehicle ahead at a substantially constant inter-vehicle distance. There is accordingly room for improvement to perform driving assistance without impeding driving.

### SUMMARY

The present disclosure provides a vehicle control device, vehicle, vehicle control method, and vehicle control program capable of performing driving assistance without impeding driving.

A vehicle control device according to a first aspect includes a reaction force control section that restricts reaction force added to an accelerator pedal of a driver's vehicle by a reaction force add section in a case in which traveling of the driver's vehicle under a specific condition continues for a fixed period of time or greater.

In the first aspect the reaction force added to the accelerator pedal of the driver's vehicle is restricted in a case in which traveling of the driver's vehicle under the specific condition continues for the fixed period of time or greater.

The reaction force added to the accelerator pedal is thereby restricted in situations in which traveling of the driver's vehicle under the specific condition continues for the fixed period of time or greater, namely, in situations in which the driver of the driver's vehicle might be thought to be performing stable driving, enabling driving assistance to be performed without impeding driving.

A second aspect is the first aspect wherein the specific condition is an inter-vehicle distance between the driver's vehicle and a vehicle ahead of the driver's vehicle being within a specific range.

In the second aspect, traveling for which the inter-vehicle distance between the driver's vehicle and the vehicle ahead lies within the specific range is taken as being traveling under the specific condition. This enables easy determination as to whether or not the driver's vehicle is traveling under the specific condition based on the inter-vehicle distance, enabling driving assistance to be performed while more certainly suppressing driving from being impeded.

A third aspect is the first aspect or the second aspect, wherein the reaction force control section determines a restriction value for the reaction force based on a continuous time period of traveling under the specific condition.

In situations in which traveling of the driver's vehicle under the specific condition continues for the fixed period of time or greater, the degree of recognition that stable driving is being performed by the driver of the driver's vehicle changes according to the continuous time period. Based on this, in the third aspect the restriction value for reaction force added to the accelerator pedal of the driver's vehicle is determined based on the continuous time period of traveling under the specific condition. This enables the restriction value for reaction force added to the accelerator pedal of the driver's vehicle to be varied according to the degree of recognition that stable driving is being performed by the driver of the driver's vehicle.

The fourth aspect is the third aspect, wherein the reaction force control section determines the reaction force restriction value so as to reduce the reaction force added to the accelerator pedal of the driver's vehicle as the continuous time period lengthens.

In situations in which traveling of the driver's vehicle under the specific condition continues for the fixed period of time or greater, the degree of recognition that stable driving is being performed by the driver of the driver's vehicle increases as the continuous time period lengthens. On this basis, in the fourth aspect, the restriction value for reaction force added to the accelerator pedal of the driver's vehicle is determined such that the reaction force added to the accelerator pedal of the driver's vehicle decreases as the continuous time period of traveling under the specific condition lengthens. This enables the restriction value for reaction force added to the accelerator pedal of the driver's vehicle to be varied according to the degree of recognition that stable driving is being performed by the driver of the driver's vehicle.

A vehicle according to a fifth aspect includes the vehicle control device of the first aspect and the reaction force add section.

The fifth aspect includes the vehicle control device of the first aspect, and so similarly to the first aspect, the fifth aspect enabling driving assistance to be performed without impeding driving.

A vehicle control method executed by a processor according to a sixth aspect, the method includes restricting reaction force added to an accelerator pedal of a driver's vehicle by a reaction force add section in a case in which traveling of the driver's vehicle under a specific condition continues for a fixed period of time or greater.

The sixth aspect, similarly to the first aspect, enables driving assistance to be performed without impeding driving.

A non-transitory storage medium storing a program executable by a processor to perform vehicle control processing according to the seventh aspect, the vehicle control processing includes restricting reaction force added to an accelerator pedal of a driver's vehicle by a reaction force add section in a case in which traveling of the driver's vehicle under a specific condition continues for a fixed period of time or greater.

The seventh aspect, similarly to the first aspect, enables driving assistance to be performed without impeding driving.

The present disclosure exhibits the advantageous effect of enabling driving assistance to be performed without impeding driving.

### BRIEF DESCRIPTION OF THE DRAWINGS

Exemplary embodiments of the present disclosure will be described in detail based on the following figures, wherein:

FIG. 1 is a block diagram illustrating a schematic configuration of an onboard system according to an exemplary embodiment;

FIG. 2 is a functional block diagram of a haptic pedal control ECU;

FIG. 3 is a functional block diagram illustrating a relationship between a first control section and a second control section;

FIG. 4 is a graph illustrating a relationship between a continuous time period and a reaction force instruction gain in a first exemplary embodiment;

FIG. 5 is a flowchart illustrating haptic pedal control processing;

FIG. 6 is an image indicting an example of a result of control by haptic pedal control processing; and

FIG. 7 is a graph illustrating a relationship between a continuous time period and reaction force instruction gain in a second exemplary embodiment.

### DETAILED DESCRIPTION

Detailed description follows regarding an example of exemplary embodiments of the present disclosure, with reference to the drawings.

### First Exemplary Embodiment

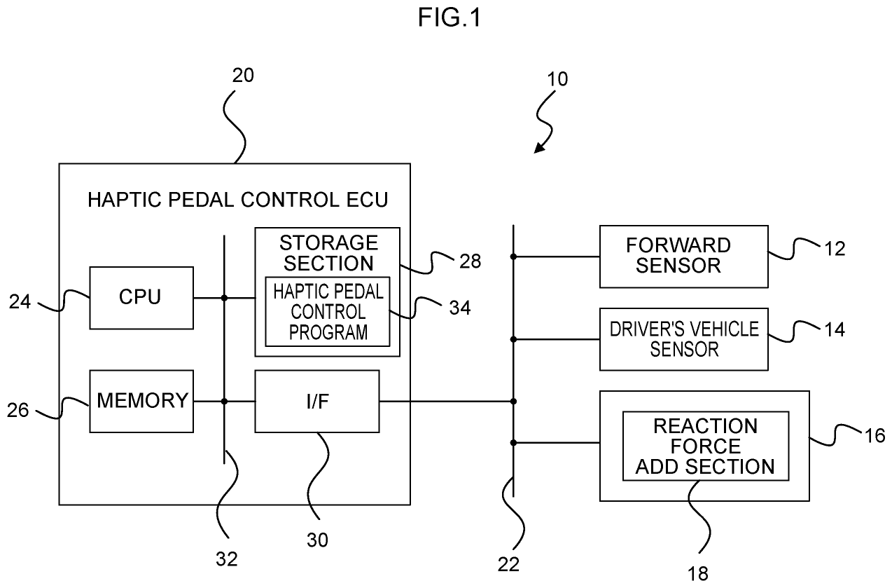

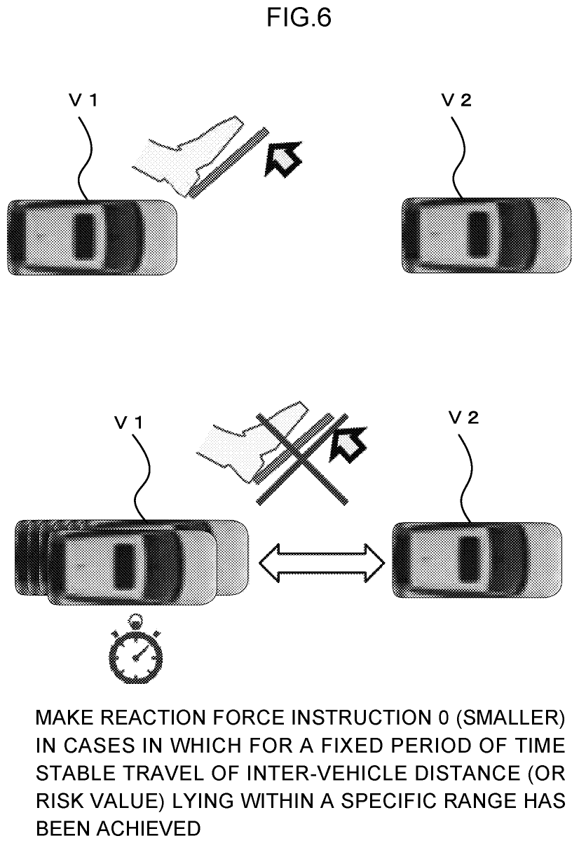

FIG. 1 illustrates an onboard system 10 according to an exemplary embodiment. The onboard system 10 is installed to a vehicle V1 (see FIG. 6) and includes a forward sensor 12, a driver's vehicle sensor 14, an accelerator pedal 16 provided with a reaction force add section 18, and a haptic pedal control ECU 20. The forward sensor 12, the driver's vehicle sensor 14, the accelerator pedal 16, and the haptic pedal control ECU 20 are each connected to a system bus 22 so as to be capable of communicating with each other.

Note that in the following the vehicle V1 installed with the onboard system 10 is referred to as “ego vehicle V1”. The driver's vehicle V1 is an example of a vehicle according to the present disclosure. Moreover, the haptic pedal control ECU 20 is an example of a vehicle control device according to the present disclosure.

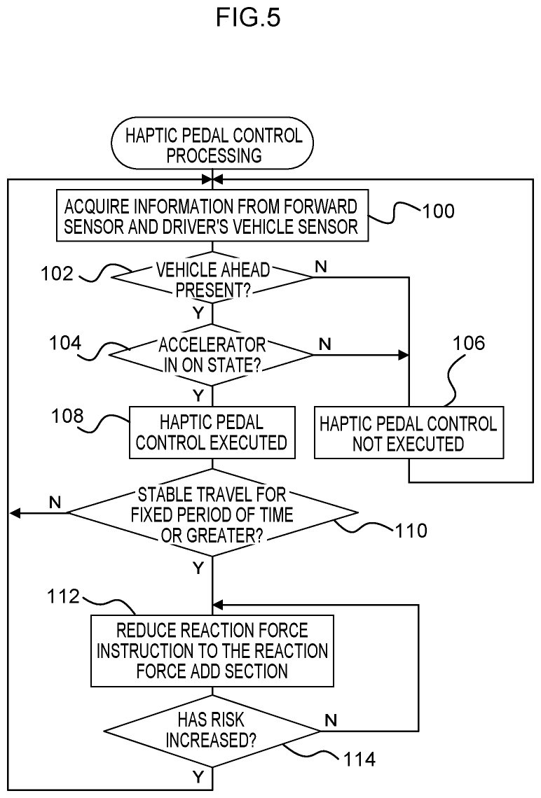

The forward sensor 12 is a sensor capable of detecting obstructions present in front of the driver's vehicle V1 and includes, for example, at least one out of a camera, radar, or light detection and ranging/laser imaging detection and ranging (LIDAR). In the present exemplary embodiment the forward sensor 12 detects the presence or absence of a vehicle ahead V2 (see FIG. 5) traveling in front of the driver's vehicle V1 and, when a vehicle ahead V2 has been detected, also detects a speed and acceleration of the vehicle ahead V2 and an inter-vehicle distance between the driver's vehicle V1 and the vehicle ahead V2. The presence or absence of the vehicle ahead V2 detected by the forward sensor 12 is output to the haptic pedal control ECU 20, together with the speed and acceleration of the vehicle ahead V2 and the inter-vehicle distance detected thereby when there is a vehicle ahead V2 present.

The driver's vehicle sensor 14 includes a speed sensor to detect the speed of the driver's vehicle V1 and an acceleration sensor to detect the acceleration of the driver's vehicle V1. The speed and acceleration of the driver's vehicle V1 detected by the driver's vehicle sensor 14 are output to the haptic pedal control ECU 20.

The accelerator pedal 16 is disposed at a lower portion of a driving seat of the driver's vehicle V1. The driver's vehicle V1 generates propulsion force to propel the driver's vehicle V1 according to a depressed amount when the accelerator pedal 16 has been depressed by a driver.

The reaction force add section 18 provided to the accelerator pedal 16 is a mechanism capable of adding reaction force to the accelerator pedal 16 and includes, for example, a servo motor connected to the accelerator pedal 16. In the present exemplary embodiment, the haptic pedal control ECU 20 outputs a reaction force instruction signal according to a magnitude of reaction force to be added to the accelerator pedal 16 by the reaction force add section 18. The reaction force add section 18 uses the servo motor to generate torque according to the magnitude of reaction force as expressed in the reaction force instruction signal input from the haptic pedal control ECU 20, such that reaction force according to the input reaction force instruction signal is added to the accelerator pedal 16.

Moreover, the reaction force add section 18 includes a stroke sensor incorporated in the servo motor to detect the depressed amount of the accelerator pedal 16. The depressed amount of the accelerator pedal 16 detected by the stroke sensor of the reaction force add section 18 is output to the haptic pedal control ECU 20.

The haptic pedal control ECU 20 includes a central processing unit (CPU) 24, memory 26 such as read only memory (ROM), random access memory (RAM) and the like, a non-transitory storage section 28 such as a hard disk drive (HDD), solid state drive (SSD), or the like, and an I/F (interface) section 30. The CPU 24, the memory 26, the storage section 28, and the I/F section 30 are each connected to an internal bus 32, so as to be capable of communicating with each other. The I/F section 30 is also connected to the system bus 22.

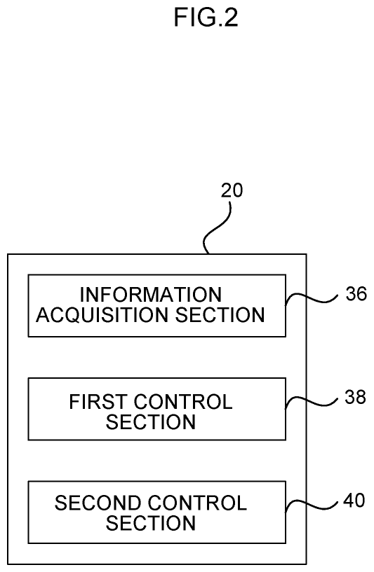

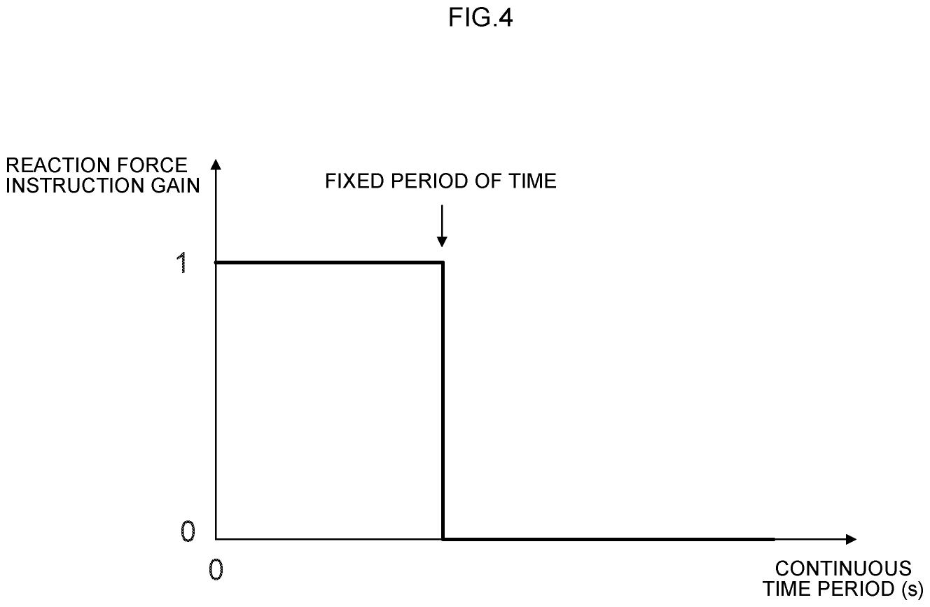

A haptic pedal control program 34 is stored in the storage section 28 of the haptic pedal control ECU 20. The haptic pedal control ECU 20 reads the haptic pedal control program 34 from the storage section 28, expands the haptic pedal control program 34 in the memory 26, and functions as an information acquisition section 36, a first control section 38 and a second control section 40 illustrated in FIG. 2 by the haptic pedal control program 34 expanded in the memory 26 being executed by the CPU 24 serving as a processor, so as to perform haptic pedal control processing (FIG. 4) as described later. Note that the haptic pedal control program 34 is an example of a vehicle control program according to the present disclosure.

The information acquisition section 36 acquires the presence or absence of the vehicle ahead V2, the speed and acceleration of the vehicle ahead V2, and the inter-vehicle distance from the forward sensor 12, and acquires the vehicle speed and acceleration of the driver's vehicle V1 from the driver's vehicle sensor 14. The information acquisition section 36 also acquires the depressed amount of the accelerator pedal 16 from the reaction force add section 18.

The first control section 38 performs haptic pedal control to control the reaction force added to the accelerator pedal 16 by the reaction force add section 18 in a case in which a vehicle ahead V2 is present and the accelerator pedal 16 is also being depressed. Namely, based on the information acquired by the information acquisition section 36, the first control section 38 computes a relative speed between the driver's vehicle V1 and the vehicle ahead V2, a relative acceleration between the driver's vehicle V1 and the vehicle ahead V2, and the like. Note that the relative speed between the driver's vehicle V1 and the vehicle ahead V2 in the present exemplary embodiment means a relative speed computed by subtracting the speed of the vehicle ahead V2 from the speed of the driver's vehicle V1.

Moreover, based on the information such as the speed of the driver's vehicle V1, and the relative speed, relative acceleration, and inter-vehicle distance between the driver's vehicle V1 and the vehicle ahead V2, the first control section 38 computes a risk value (see following Equation (1)) expressing a possibility of the driver's vehicle V1 running into the back of the vehicle ahead V2.

Risk value=f(speed of ego vehicle,relative speed,relative acceleration,inter-vehicle distance, . . . ) Equation (1)

The first control section 38 then generates and outputs a reaction force instruction instructing a magnitude of reaction force to be added to the accelerator pedal 16 such that the reaction force added to the accelerator pedal 16 increases as the computed risk value gets higher.

Based on the information acquired by the information acquisition section 36, the second control section 40 performs reaction force restriction control to restrict the reaction force added to the accelerator pedal 16 of the driver's vehicle V1 by the reaction force add section 18 in a case in which travel under a specific condition of the driver's vehicle V1 has continued for a fixed period of time or greater. Note that an example of travel under a specific condition described above is travel such that the inter-vehicle distance between the driver's vehicle V1 and the vehicle ahead V2 is within a specific range.

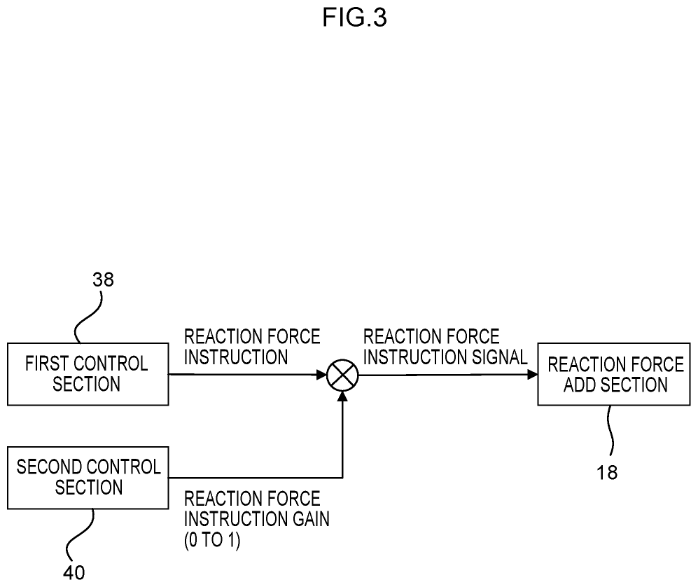

As illustrated in FIG. 3, in the present exemplary embodiment, the second control section 40 outputs a reaction force instruction gain as a multiplier for application to the reaction force instruction output from the first control section 38, and the result of multiplying the reaction force instruction and the reaction force instruction gain together is output as a reaction force instruction signal from the haptic pedal control ECU 20 to the reaction force add section 18. The second control section 40 implements restricting (reducing) the reaction force added to the accelerator pedal 16 of the driver's vehicle V1 by outputting a reaction force instruction gain at a value less than 1.

The second control section 40 reduces the reaction force added to the accelerator pedal 16 of the driver's vehicle V1 in a case in which the continuous time period of travel under the specific condition of the driver's vehicle V1 is a fixed period of time or greater, so as to be less than the reaction force added to the accelerator pedal 16 of the driver's vehicle V1 in a case in which the continuous time period of travel under the specific condition of the driver's vehicle V1 is less than the fixed period of time. As an example, in the first exemplary embodiment the second control section 40 makes the reaction force instruction gain 1 in a case in which the continuous time period is less than the fixed period of time, and makes the reaction force instruction gain 0 in a case in which the continuous time period is the fixed period of time or greater, as illustrated in FIG. 4. Note that, for example, a value of a few seconds may be applied as the fixed period of time.

Moreover, varying the reaction force instruction gain in a case in which the continuous time period of travel under the specific condition of the driver's vehicle V1 is the fixed period of time or greater by varying in a single step shape as illustrated in FIG. 4 is not always preferable because it results in a sudden decrease in the reaction force added to the accelerator pedal 16 of the driver's vehicle V1, with the possibility that this might induce a sudden depressing of the accelerator pedal 16. Therefore in a case in which the continuous time period of travel under the specific condition of the driver's vehicle V1 is the fixed period of time or greater the second control section 40 may reduce the reaction force instruction gain gradually stepwise in a plural step shape, such that the reaction force instruction gain becomes 0 after the elapse of a specific period of time. Note that the specific period of time is, for example, a value of a few seconds. The second control section 40 is an example of a reaction force control section of the present disclosure.

Next, description follows regarding haptic pedal control processing executed by the haptic pedal control ECU 20 while the ignition switch of the driver's vehicle V1 is turned ON as operation of the present exemplary embodiment, with reference to FIG. 5.

At step 100 of the haptic pedal control processing, the information acquisition section 36 acquires the presence or absence of a vehicle ahead V2, the vehicle speed and acceleration of the vehicle ahead V2, and the inter-vehicle distance from the forward sensor 12, and acquires the vehicle speed and acceleration of the driver's vehicle V1 from the driver's vehicle sensor 14, and acquires the depressed amount of the accelerator pedal 16 from the reaction force add section 18.

At step 102, the first control section 38 determines whether or not there is a vehicle ahead V2 traveling in front of the driver's vehicle V1 based on the information expressing the presence or absence of the vehicle ahead V2 acquired by the information acquisition section 36 from the forward sensor 12. Processing transitions to step 106 in a case in which negative determination is made at step 102. Processing then returns to step 100 without the first control section 38 executing the haptic pedal control at step 106.

The processing transitions to step 104 in a case in which affirmative determination is made at step 102. Then at step 104, the first control section 38 determines whether or not the accelerator pedal 16 of the driver's vehicle V1 is in a depressed state based on the depressed amount of the accelerator pedal 16 as acquired by the information acquisition section 36 from the reaction force add section 18. Processing transitions to step 106 when negative determination is made at step 104. Processing then returns to step 100 without the first control section 38 executing the haptic pedal control at step 106.

However, processing transitions to step 108 in a case in which affirmative determination is made at step 104. The first control section 38 starts executing haptic pedal control at step 108. Namely, the first control section 38 computes a risk value according to Equation (1) above based on information such as the speed of the driver's vehicle V1, and the relative speed, relative acceleration, and inter-vehicle distance between the driver's vehicle V1 and the vehicle ahead V2. The first control section 38 then generates and outputs a reaction force instruction such that the reaction force for adding to the accelerator pedal 16 increases as the computed risk value gets higher.

Note that the second control section 40 outputs a reaction force instruction gain=1 during a period in which negative determination is made at step 110, as described next. Thus during this period “a reaction force indicated by the reaction force instruction=a reaction force indicated by the reaction force instruction signal”, and a reaction force according to the risk value computed by the first control section 38 is added to the accelerator pedal 16 by the reaction force add section 18.

Next, at step 110 the second control section 40 clocks the continuous time period of a state in which the driver's vehicle V1 is traveling under the specific condition, and determines whether or not the clocked continuous time period is the fixed period of time or greater. Note that in the present exemplary embodiment a state in which the inter-vehicle distance between the driver's vehicle V1 and the vehicle ahead V2 is within a specific range is applied as the state in which the driver's vehicle V1 is traveling under the specific condition. As an example, cases in which a state of a difference between a minimum value and a maximum value of the inter-vehicle distance between the driver's vehicle V1 and the vehicle ahead V2 is a specific value (5 m, for example) or less has continued for the fixed period of time (5 s, for example) are determined to be a state in which traveling of the driver's vehicle V1 under the specific condition has continued for the fixed period of time or greater. Processing returns to step 100 in a case in which negative determination is made at step 110, and the processing of step 100 onward is repeated.

However, processing transitions to step 112 in a case in which affirmative determination is made at step 110. At step 112 the second control section 40 immediately sets the reaction force instruction gain for output to 0. Alternatively, the second control section 40 may reduce the reaction force instruction gain for output gradually stepwise such that the reaction force instruction gain becomes 0 after a specific period of time. The reaction force expressed by the reaction force instruction signal output to the reaction force add section 18 thereby immediately becomes 0 in a case in which affirmative determination is made at step 110, or is reduced gradually stepwise so as to becomes 0 after a specific period of time in such cases.

Note that in a case in which the state of traveling of the driver's vehicle V1 under the specific condition has continued, the inter-vehicle distance between the driver's vehicle V1 and the vehicle ahead V2 is progressing at a substantially fixed value, and so the risk value computed by the first control section 38 is also progressing at a substantially fixed value, as is apparent from Equation (1) above. Thus hitherto the reaction force added to the accelerator pedal 16 would not be reduced in a case in which the state of traveling of the driver's vehicle V1 under the specific condition has continued, irrespective of this being a situation in which a driver of the driver's vehicle V1 might be thought to be performing stable driving.

In contrast thereto, in the first exemplary embodiment, in a case in which a state of traveling of the driver's vehicle V1 under the specific condition has continued, the second control section 40 performs reaction force restriction control that starts to immediately reduce the reaction force instruction gain to 0, and either achieves a reaction force instruction gain of immediately after starting, or makes the reaction force instruction gain 0 gradually stepwise over a specific period of time. The reaction force added to the accelerator pedal 16 is accordingly quickly reduced thereby in a situation in which a driver of the driver's vehicle V1 might be thought to be performing stable driving, namely, in a situation in which a state of the inter-vehicle distance between the driver's vehicle V1 and the vehicle ahead V2 lying within a specific range has continued for a fixed period of time or greater.

Next at step 114, the second control section 40 determines whether or not the risk of the driver's vehicle V1 has increased. This determination may, for example, be implemented by determining whether or not the risk value computed by the first control section 38 has become greater than the risk value computed by the first control section 38 at the timing of affirmative determination of previous step 110 and greater therefrom by at least a specific value. Processing returns to step 112 when negative determination is made at step 114, and then step 112 and step 114 are repeated until affirmative determination is made at step 114. Moreover, processing returns to step 100 when affirmative determination is made at step 114, and the processing of step 100 onward is repeated.

The control illustrated in FIG. 6 is, for example, implemented by the haptic pedal control processing described above. Namely, in an original situation in which the inter-vehicle distance between the driver's vehicle V1 and the vehicle ahead V2 has reached a given magnitude, as illustrated at an upper part of FIG. 6, the haptic pedal control is performed by the first control section 38, but the reaction force restriction control is not performed by the second control section 40. A reaction force according to the risk value is accordingly added to the accelerator pedal 16, suppressing the driver of the driver's vehicle V1 from depressing the accelerator pedal 16 excessively.

Moreover thereafter, affirmative determination is made at step 110 for cases in which for the fixed period of time or greater a state has continued of the difference between the minimum value and the maximum value of inter-vehicle distance between the driver's vehicle V1 and the vehicle ahead V2 being a specific value or less, as illustrated at a lower part of FIG. 6. Then in this situation, the haptic pedal control is performed by the first control section 38 and also the reaction force restriction control is performed by the second control section 40, such that the reaction force added to the accelerator pedal 16 is reduced from a reaction force according to the risk value and becomes 0 after the specific period of time. The required depressing force to maintain the depressed amount of the accelerator pedal 16 is accordingly reduced, enabling a reduction in the burden on the driver of the driver's vehicle V1.

Thus in the first exemplary embodiment, the second control section 40 of the haptic pedal control ECU 20 restricts the reaction force added to the accelerator pedal 16 of the driver's vehicle V1 by the reaction force add section 18 in a case in which traveling of the driver's vehicle V1 under the specific condition continues for the fixed period of time or greater. This means that the reaction force added to the accelerator pedal 16 is restricted in a situation in which traveling of the driver's vehicle V1 under the specific condition continues for the fixed period of time or greater, namely, in a situation in which the driver of the driver's vehicle V1 might be thought to be performing stable driving, enabling driving assistance to be performed without impeding driving.

Moreover, in the first exemplary embodiment, traveling under the specific condition is traveling while the inter-vehicle distance between the driver's vehicle V1 and the vehicle ahead V2 is within a specific range. This enables easy determination as to whether or not the driver's vehicle V1 is traveling under the specific condition based on the inter-vehicle distance, enabling driving assistance to be performed while more certainly suppressing driving from being impeded.

### Second Exemplary Embodiment

Next, description follows regarding a second exemplary embodiment of the present disclosure. Note that the second exemplary embodiment is configured the same as the first exemplary embodiment, and so each part will be appended with the same reference numeral, and description of such configuration omitted.

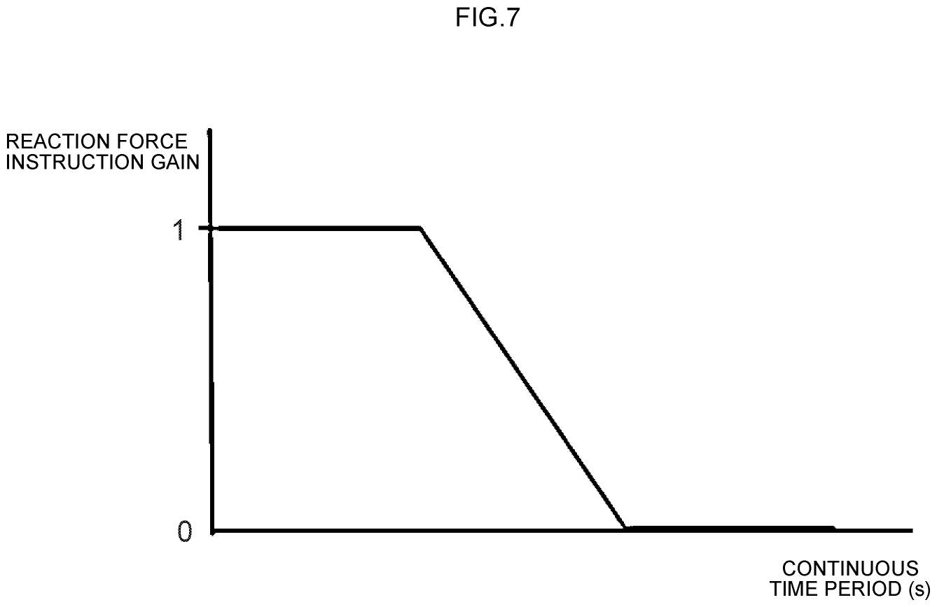

In the second exemplary embodiment, the second control section 40 determines a restriction value (reaction force instruction gain) for reaction force added to the accelerator pedal 16 of the driver's vehicle V1 based on the continuous time period of the driver's vehicle V1 traveling under the specific condition. More specifically, in the second exemplary embodiment, for example as illustrated in FIG. 7, the second control section 40 determines the restriction value (reaction force instruction gain) for reaction force added to the accelerator pedal 16 of the driver's vehicle V1 so as to reduce the reaction force added to the accelerator pedal 16 of the driver's vehicle V1 as the continuous time period of the driver's vehicle V1 traveling under the specific condition lengthens. In the second exemplary embodiment the relationship between the continuous time period and the reaction force instruction gain illustrated in FIG. 7 is pre-stored in the storage section 28 in a map format, for example.

In the following only the parts of the haptic pedal control processing according to the second exemplary embodiment that differ from those of the first exemplary embodiment will be described. At step 112 of the haptic pedal control processing according to the second exemplary embodiment, the second control section 40 reads from the storage section 28 the relationship between the continuous time period and the reaction force instruction gain that had been pre-stored in the storage section 28 in a map format or the like. The second control section 40 then identifies, from the read relationship between the continuous time period and the reaction force instruction gain, a value of the reaction force instruction gain corresponding to the continuous time period of the state in which the inter-vehicle distance between the driver's vehicle V1 and the vehicle ahead V2 lies within the specific range, and outputs the identified value of reaction force instruction gain.

Thus in the second exemplary embodiment, the second control section 40 performs the reaction force restriction control when the continuous time period of the driver's vehicle traveling under the specific condition, namely the continuous time period of a state in which the inter-vehicle distance between the driver's vehicle V1 and the vehicle ahead V2 lies within the specific range, is the fixed period of time or greater, and reduces the reaction force instruction gain according to increase in the continuous time period. This means that the reaction force being added to the accelerator pedal 16 is reduced quickly in a situation in which the driver of the driver's vehicle V1 might be thought to be performing stable driving, namely, in a situation in which a state has continued for the fixed period of time or greater of the inter-vehicle distance between the driver's vehicle V1 and the vehicle ahead V2 lying within the specific range.

In this manner, in the second exemplary embodiment, the second control section 40 determines a restriction value for the reaction force added to the accelerator pedal 16 of the driver's vehicle V1 based on the continuous time period of the driver's vehicle V1 traveling under the specific condition. This accordingly enables the restriction value for the reaction force added to the accelerator pedal 16 of the driver's vehicle V1 to be changed according to a degree of recognition that stable driving is being performed by the driver of the driver's vehicle V1.

Moreover, in the second exemplary embodiment, the second control section 40 determines the restriction value for reaction force added to the accelerator pedal 16 of the driver's vehicle V1 so as to reduce the reaction force added to the accelerator pedal 16 of the driver's vehicle V1 as the continuous time period of the driver's vehicle V1 traveling under the specific condition lengthens. This enables the restriction value for the reaction force added to the accelerator pedal 16 of the driver's vehicle V1 to be changed according to the degree of recognition that stable driving is being performed by the driver of the driver's vehicle V1.

Note that an embodiment has been described in the above exemplary embodiment in which whether or not the driver's vehicle V1 is traveling under the specific condition is a determined based on the inter-vehicle distance between the driver's vehicle V1 and the vehicle ahead V2. However, the present disclosure is not limited thereto and, for example, whether or not the driver's vehicle V1 is traveling under the specific condition may be determined based a risk value computed by the first control section 38. Specifically, for example, determination that the driver's vehicle V1 traveling under the specific condition continues for the fixed period of time or greater may be made for cases in which fluctuation of the risk value lies within a specific range for a fixed period of time.

Moreover, although a configuration has been described in the above exemplary embodiment in which, as the reaction force add section 18, a given reaction force is added to the accelerator pedal 16 by generating a specific torque using a servo motor, there is no limitation thereto. The reaction force add section 18 may have a configuration to add a reaction force to the accelerator pedal 16 by, for example, a mechanism utilizing a cylinder and hydraulic pressure or the like.

Moreover, although an embodiment has been described in the above exemplary embodiment in which haptic pedal control processing is implemented by the CPU 24 executing the haptic pedal control program 34, there is no limitation thereto and the haptic pedal control processing may be executed by a processor other than the CPU 24. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The haptic pedal control processing may be executed by any one of these various types of processors, or may be executed by a combination of two or more of the same type or different types of processors, such as plural FPGAs, or a combination of a CPU and an FPGA.

In the exemplary embodiments described above an embodiment has been described in which the haptic pedal control program 34 that is an example of a vehicle control program according to the present disclosure has been pre-stored (installed) in the storage section 28. However, the vehicle control program according to the present disclosure may be provided in a format stored on a non-transitory storage medium such as a compact disc read only memory (CD-ROM), digital versatile disc read only memory (DVD-ROM), universal serial bus (USB) memory, or the like. Moreover, the vehicle control program according to the present disclosure may be provided in a format downloadable from an external device over a network.

What is claimed is:

1. A vehicle control device comprising:
a memory; and
a processor coupled to the memory, wherein the processor is configured to:
restrict reaction force added to an accelerator pedal of a driver's vehicle by a reaction force add section configured to add reaction force to the accelerator pedal of the driver's vehicle in a case in which traveling of the driver's vehicle under a specific condition continues for a fixed period of time or greater.

2. The vehicle control device of claim 1, wherein the specific condition is an inter-vehicle distance between the driver's vehicle and a vehicle ahead of the driver's vehicle being within a specific range.

3. The vehicle control device of claim 1, wherein the processor is configured to:
determine a restriction value for the reaction force based on a continuous time period of traveling under the specific condition.

4. The vehicle control device of claim 3, wherein the processor is configured to:
determine the reaction force restriction value so as to reduce the reaction force added to the accelerator pedal of the driver's vehicle by the reaction force add section as the continuous time period lengthens.

5. A vehicle comprising:
the vehicle control device of claim 1; and
the reaction force add section.

6. A vehicle control method executed by a processor, the vehicle control method comprising:
restricting reaction force added to an accelerator pedal of a driver's vehicle by adding reaction force to the accelerator pedal of the driver's vehicle in a case in which traveling of the driver's vehicle under a specific condition continues for a fixed period of time or greater.

7. A non-transitory storage medium storing a program executable by a processor to perform vehicle control processing, the vehicle control processing comprising:
restricting reaction force added to an accelerator pedal of a driver's vehicle by adding reaction force to the accelerator pedal of the driver's vehicle in a case in which traveling of the driver's vehicle under a specific condition continues for a fixed period of time or greater.
